(19) United States
(12) Patent Application Publication
(10) Pub. No.: US 2025/0084630 A1
(43) Pub. Date: Mar. 13, 2025

(54) POSITIONING SYSTEM FOR SEWER INSPECTION AND/OR MAINTENANCE SYSTEMS

(71) Applicant: iPEK International GmbH, Sulzberg (DE)

(72) Inventors: Vreni Tolsdorf, Kempten (DE); Johannes Wiese, Immenstadt (DE); Simon Schweizer, Kempten (DE); Anton Krämer, Kempten (DE)

(21) Appl. No.: 18/883,977

(22) Filed: Sep. 12, 2024

(30) Foreign Application Priority Data
Sep. 13, 2023 (DE) 10 2023 124 733.6

(51) Int. Cl. E03F 7/12; B25J 18/00

(52) U.S. Cl. CPC E03F 7/12; B25J 18/00

(57) ABSTRACT

A positioning system for sewer inspection and/or maintenance systems for positioning a device in a sewer is provided, wherein the positioning system has a lifting arm which is arranged on a base carrier, wherein
the lifting arm can be deflected or pivoted relative to the base carrier via a pivot axis,
the base carrier can be arranged on a crawler of the sewer inspection and/or maintenance system, and
the base carrier
is movable or displaceable along a movement axis relative to the crawler, and/or
can be rotated about an axis of rotation relative to the crawler.

### CROSS-REFERENCE TO RELATED APPLICATIONS

This application claims priority to German Patent Application Serial No. DE 10 2023 124 733.6, filed Sep. 13, 2023, the entire disclosure of which is hereby incorporated herein by reference in its entirety.

### FIELD OF THE INVENTION

The invention relates to a positioning system for sewer inspection and/or maintenance systems and to a sewer inspection and/or maintenance system with a crawler and a positioning system. The positioning system is configured to position devices in a sewer.

### BACKGROUND OF THE INVENTION

Sewer inspection systems with a crawler and a positioning system arranged thereon are known from the prior art, for example from EP 2 689 227 A1. FIG. 1 shows the system known from EP 2 689 227 A1. The system consists of a crawler F and a lifter H arranged thereon. The lifter H has several joints HG. An inspection camera IK is arranged at the free end of the lifter H. The lifter H can be raised or lowered by means of pneumatic actuating means so that the camera attached to the lifter is also raised or lowered. The disadvantage here, however, is that the camera can only be raised or lowered, which considerably limits the possibilities for sewer inspection. A further disadvantage is that the camera cannot be raised or lowered exactly vertically, but instead describes a curve when raised or lowered, as indicated by the arc K in FIG. 1. This can result in the distance from the camera to an area to be inspected changing, which may require readjusting the camera's focus.

### OBJECT OF THE INVENTION

The object of the present invention is therefore to provide solutions that expand the possibilities of sewer inspection and/or sewer maintenance.

### SUMMARY OF THE INVENTION

This object is achieved with a positioning system for sewer inspection and/or maintenance systems for positioning a device in a sewer, and with a sewer inspection and/or maintenance system with a positioning system according to the independent claims. Advantageous embodiments of the invention are set forth in the specific dependent claims.

Accordingly, a positioning system for sewer inspection and/or maintenance systems for positioning a device in a sewer is provided, wherein the positioning system has a lifting arm which is arranged on a base carrier, wherein
the lifting arm can be deflected or pivoted relative to the base carrier via a pivot axis,
the base carrier can be arranged on a crawler of the sewer inspection and/or maintenance system, and
the base carrier
is movable or displaceable along a movement axis relative to the crawler, and/or
can be rotated about an axis of rotation relative to the crawler.

This extends sewer inspection and/or maintenance systems by several degrees of freedom with regard to the use of the device, which significantly increases the possibilities for sewer inspection or maintenance.

Sewer inspection and/or maintenance system comprising a crawler and a positioning system for positioning devices in a sewer, wherein
the positioning system has a lifting arm which is arranged on a base carrier,
the base carrier is arranged on the crawler,
the lifting arm can be deflected or pivoted relative to the base carrier via a pivot axis, and
the base carrier
is movable or displaceable along a movement axis relative to the crawler, and/or
can be rotated about an axis of rotation relative to the crawler.

It is advantageous if a receiving unit is arranged at the free end of the lifting arm for receiving, in particular detachably receiving, the device.

The lifting arm can have at least two lifting arm sections which are coupled to one another in an articulated manner, preferably via a swivel joint, wherein the free end of one of the two lifting arm sections is arranged on the base carrier in a deflectable or pivotable manner.

It can be advantageous
if the base carrier is assigned a first controllable actuating means which is adapted
to deflect or pivot the lifting arm relative to the base carrier via the pivot axis, and/or
to move or displace the base carrier
along the movement axis relative to the crawler, and/or
to rotate it about the axis of rotation relative to the crawler,
and/or
if one of the two lifting arm sections is assigned a second controllable actuating means which is adapted to move the one lifting arm section relative to the other lifting arm section.

An absolute encoder can be assigned to the first controllable actuating means and/or the second controllable actuating means. Reference runs of the positioning system can thus be avoided.

It may be advantageous if the receiving unit can be pivoted relative to the lifting arm over a predetermined angular range, preferably over an angular range of 180°, particularly preferably over an angular range of 270°. This adds another degree of freedom to the positioning system.

The receiving unit can
be rotatably mounted at the free end of the lifting arm, and/or
be designed in two parts, wherein a first part of the receiving unit is rotatable relative to the second part of the receiving unit.

In one embodiment of the invention, at least one pressurized duct can be formed in the lifting arm.

The pressurized duct can be designed as a continuous pressurized duct from one end to the other end of the lifting arm, which is coupled to the crawler on the crawler side.

The pressurized duct can have connecting means for supplying a fluid (gas or liquid) to it, in particular under high pressure.

What is also provided is a positioning system for sewer inspection and/or maintenance systems for positioning a device in a sewer, wherein the positioning system has a lifting arm, wherein the device can be arranged at a free end of the lifting arm, can provide for the stabilization of the device that
the device can be arranged indirectly via a gimbal at the free end of the lifting arm, and/or
the positioning system is movable in such a way that the movements of the positioning system correspond to the function of a gimbal.

### BRIEF DESCRIPTION OF THE DRAWINGS

Further details and features of the invention as well as specific, particularly advantageous exemplary embodiments of the invention will be apparent from the following description in conjunction with the drawing. In the figures:

FIG. 1 shows a sewer inspection system known from the prior art with a lifter arranged thereon;

FIG. 2 shows an inventive positioning system according to a first aspect of the invention;

FIG. 3 shows an inventive positioning system according to a second aspect of the invention;

FIG. 4 shows a first application example of a positioning system according to the invention;

FIG. 5 shows a second application example of a positioning system according to the invention; and

FIGS. 6A-6C show an exemplary embodiment of a receiving unit of a positioning system according to the invention.

### DETAILED DESCRIPTION OF THE INVENTION

The positioning system according to the invention advantageously makes it possible to significantly expand the possibilities of sewer inspection and/or sewer maintenance and, moreover, to simplify sewer inspections and/or sewer maintenance. Unlike positioning systems known from the prior art, such as lifters as known from EP 2 689 227 A1, which can only be raised or lowered, the positioning system according to the invention has significantly more degrees of freedom, whereby the head of the positioning system (i.e., the free end of the positioning system to which a device, such as a camera, is attached) can be positioned almost arbitrarily in the sewer.

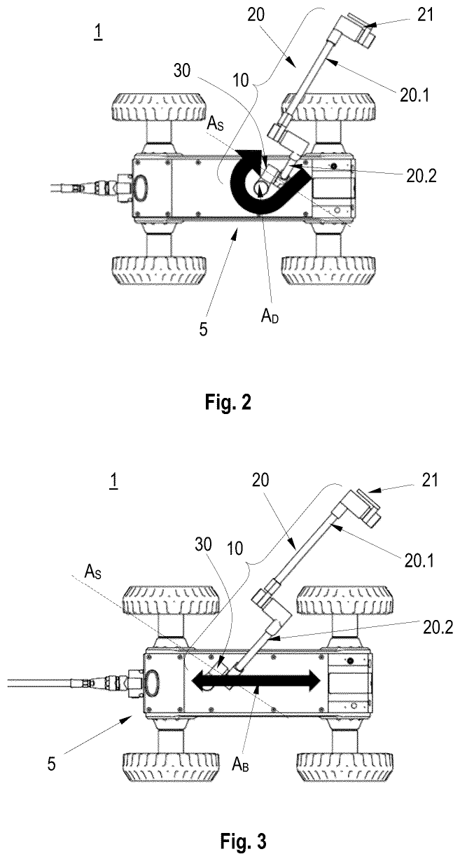

FIG. 2 shows an inventive positioning system according to a first aspect of the invention.

A positioning system 10, which essentially has one lifting arm 20, is provided on a crawler 5 which can be moved or displaced in a sewer. The lifting arm 20 can consist of several lifting arm sections 20.1, 20.2, wherein more than two lifting arm sections can be provided. A receiving unit or device carrier 21 can be arranged at the free end of the lifting arm 20 for receiving, in particular detachably receiving, a device G. The device G can comprise a tool, a camera, sensors or the like.

The lifting arm 20 is arranged on a base carrier 30. The base carrier 30 is in turn arranged or arrangeable on the crawler 5. It can be advantageous if the base carrier is detachably arranged on the crawler. This allows the lifting arm 20 to be replaced, if necessary, or to be removed when it is not needed.

The lifting arm 20 is hinged to the base carrier 30, preferably in such a way that it can be deflected or pivoted relative to the base carrier 30 via a pivot axis A_{S}. This allows the lifting arm to be raised or lowered.

The base carrier 30 is rotatable about an axis of rotation A_{D} relative to the crawler 5, preferably in both directions. The base carrier 30 is preferably rotatable over an angle of at least 90°, particularly preferably over an angle of 180°, very particularly preferably over an angle of 360°, about an axis of rotation A_{D}. If, for example, a camera is attached to the lifting arm 20 as device G, an all-round view or 360° recording can be realized with appropriate dimensioning and alignment of the lifting arm 20 or lifting arm sections 20.1, 20.2, without the camera itself having to be moved relative to the lifting arm. According to another application example, the camera can be aligned for example perpendicular to the pipe wall.

FIG. 3 shows an inventive positioning system according to a second aspect of the invention.

A positioning system 10, which essentially has one lifting arm 20, is provided on a crawler 5 which can be moved or displaced in a sewer. The lifting arm 20 can consist of several lifting arm sections 20.1, 20.2, wherein more than two lifting arm sections can be provided. A receiving unit or device carrier 21 can be arranged at the free end of the lifting arm 20 for receiving, in particular detachably receiving, a device G. The device G can comprise a tool, a camera, sensors or the like.

The lifting arm 20 is arranged on a base carrier 30. The base carrier 30 is in turn arranged or arrangeable on the crawler 5. It can be advantageous if the base carrier is detachably arranged on the crawler. This allows the lifting arm 20 to be replaced, if necessary, or to be removed when it is not needed.

The lifting arm 20 is hinged to the base carrier 30, preferably in such a way that it can be deflected or pivoted relative to the base carrier 30 via a pivot axis A_{S}. This allows the lifting arm to be raised or lowered.

The base carrier 30 is movable relative to the crawler along a movement axis A_{B}. This means that the base carrier 30 can be displaced or moved along said movement axis A_{B}. In the embodiment shown in FIG. 3, the movement axis A_{B} extends substantially parallel to the longitudinal axis of the crawler, i.e., the base carrier 30 can be moved or displaced forwards or backwards on the crawler 5. However, according to an alternative embodiment, the movement axis A_{B} can also extend at a certain angle relative to the longitudinal axis of the crawler, for example at 90° or perpendicular; in that case, the base carrier 30 can be displaced laterally on the crawler 5.

For this purpose, guide means (not shown in FIG. 3) can be provided on the crawler 5, preferably on the upper side of the crawler, which receive the base carrier and in which the base carrier 30 is guided. Actuating means, such as servo motors, may be provided for moving the base carrier along the guide means. Alternatively, the guide means and actuating means can also be implemented using linear axes with spindle drive. In principle, all guide means and actuating means can be used, provided they are suitable for moving the base carrier 30 along a movement axis A_{B}.

According to another aspect of the invention, the embodiments shown in FIG. 2 and FIG. 3 can be combined. A base carrier 30 is then arranged on the crawler 5, which is movable relative to the base carrier along a movement axis A_{B} (as described with reference to FIG. 3), wherein the base carrier 30 is rotatable about an axis of rotation A_{D} relative to the crawler 5 (as described with reference to FIG. 2).

In the two embodiments of the invention shown in FIG. 2 and FIG. 3, the lifting arm 20 has two lifting arm sections 20.1, 20.2. However, more than two lifting arm sections can be provided. Two lifting arm sections in each case are coupled together in an articulated manner so that one lifting arm section can be moved relative to the other lifting arm section. To move the individual lifting arm sections, suitable actuating means can be assigned to each of them.

Corresponding actuating means can also be assigned to the base carrier in order to rotate the base carrier about the axis of rotation A_{D}. An actuating means of the base carrier can also be provided to deflect the lifting arm relative to the base carrier (about the pivot axis A_{S}).

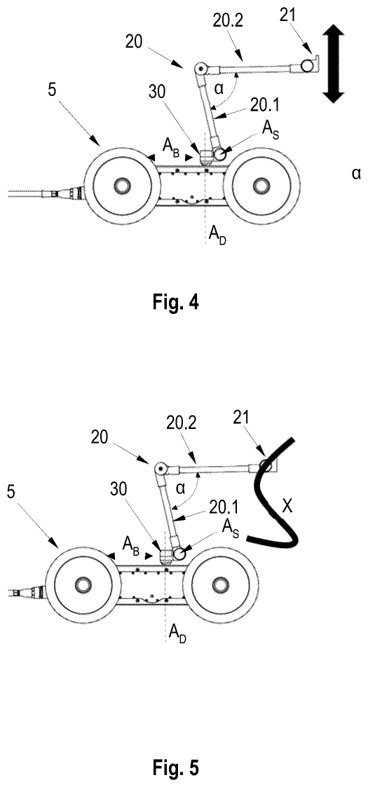

FIG. 4 shows a first application example of a positioning system according to the invention.

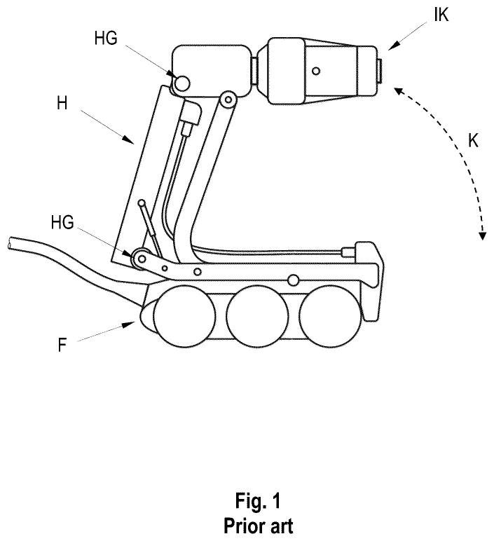

A positioning system 10 according to the invention is arranged on the crawler 5, as described above. Here, the positioning system 10 has a lifting arm 20 that consists of two lifting arm sections 20.1 and 20.2. The lifting arm sections are connected to each other in an articulated manner so that the angle α between the two lifting arm sections can be changed. The lifting arm 20 can be deflected about the pivot axis A_{S} in order to raise or lower the free end of the lifting arm or a receiving unit 21 arranged at the free end. In order to maintain the alignment of the receiving unit 21 during raising or lowering, the angle α between the two lifting arm sections 20.1 and 20.2 is continuously adjusted such that when the first lifting arm section 20.1 is pivoted relative to the base carrier 30, the second lifting arm section 20.2 always remains horizontally aligned. Without additional measures, the receiving unit 21 describes a curve when raised/lowered, as explained with reference to FIG. 1 of the prior art.

According to the invention, however, when raising or lowering the receiving unit 21, the base carrier 30 can be moved along the movement axis A_{B} forwards or backwards relative to the crawler. This makes it possible for the receiving unit 21 to be moved linearly or vertically when raised or lowered, as indicated by the double arrow shown in FIG. 4. This avoids, in particular, the need to move the crawler itself in order to achieve this linear or vertical movement of the receiving unit. This is because vibrations may occur during the journey, in particular on uneven or dirty surfaces, which vibrations can have a negative impact on inspection or maintenance.

FIG. 5 shows a second application example of a positioning system according to the invention.

A positioning system 10 according to the invention is arranged on the crawler 5, as described above with reference to FIG. 2 and FIG. 3. Here, the positioning system 10 has a lifting arm 20 that consists of two lifting arm sections 20.1 and 20.2. The lifting arm sections are connected to each other in an articulated manner. The lifting arm 20 can be deflected about the pivot axis A_{S} in order to raise or lower the free end of the lifting arm or a receiving unit 21 arranged at the free end.

According to the invention, it is provided for the two lifting arm sections 20.1 and 20.2 to be movable relative to each other and for the lifting arm as such to be pivotable (raised/lowered) relative to the base carrier 30. The base carrier 30 can be furthermore rotated about the axis of rotation A_{D} and moved along the movement axis A_{B}. In this configuration, the positioning system 10 can be moved such that the free end of the lifting arm can be moved freely in all three dimensions, as illustrated by motion path X in FIG. 5.

The positioning system 10 can comprise a pressurized duct that extends from the base carrier 30 to the free end or to the receiving unit 21. The pressurized duct can be coupled, on the crawler side, to the crawler 5 or to a pressurization device of the crawler. The pressurization device can be adapted to pressurize the pressurized duct with a fluid (gas or liquid) or to supply a fluid (gas or liquid) to the pressurized duct. The fluid is transported all the way to the receiving unit 21 through the pressurized duct. A flushing nozzle can be arranged on the receiving unit 21 by means of appropriately designed connecting means, to which flushing nozzle the fluid can be supplied (under high pressure, if necessary).

The positioning system 10 according to the invention and a flushing nozzle arranged on the receiving unit 21 can be used, for example, to provide a high-pressure water jet which can be specifically directed at a specific point in the sewer or can be specifically moved along a path. In contrast to conventional flushing devices, which deliver several water jets in a non-specific manner in several directions, it is here possible to carry out a cleaning process much more quickly (only what needs to be cleaned is cleaned) and with much less water (since no water is needed for sewer sections that do not need to be cleaned). Instead of water, air can be supplied to the flushing nozzle via the pressurized duct.

Alternatively, the pressurized duct or another pressurized duct can be provided to guide electrical lines to the receiving unit 21 or to actuating means of the positioning system 10.

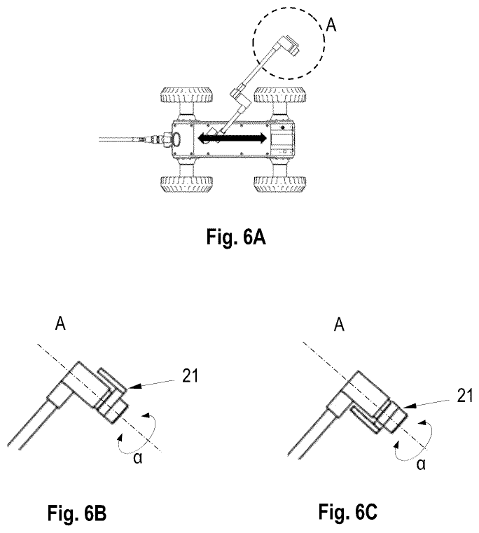

FIGS. 6A-6C show an exemplary embodiment of a receiving unit 21 of a positioning system according to the invention.

A receiving unit 21 for receiving, in particular detachably receiving, a device G is arranged at the front or free end of the lifting arm 20. The receiving unit 21 can be pivoted relative to the lifting arm 20 or relative to the lifting arm section 20.2 over a predetermined angular range a, preferably over an angular range of 180°, particularly preferably over an angular range of 270°. This allows, for example, a camera arranged on the receiving unit 21 to be pivoted by 180°. The same camera can be used for both forward and reverse travel. FIG. 6B shows a receiving unit 21 which is oriented towards the front, while FIG. 6C shows a receiving unit 21 which is pivoted by 180° and is therefore oriented towards the rear.

In another aspect of the invention, it may be advantageous to stabilize a device arranged at the free end of the lifting arm 20 or at the receiving unit 21. For this purpose, the device can be arranged indirectly via a gimbal at the free end of the lifting arm or at the receiving unit 21. Alternatively, it is also possible for the positioning system, in particular the lifting arm, to be movable such that the movement of the positioning system corresponds to the function of a gimbal or that the positioning system takes over the function of a gimbal.

We claim:

1. A positioning system for sewer inspection and/or maintenance systems for positioning a device in a sewer, wherein the positioning system has a lifting arm which is arranged on a base carrier, wherein
the lifting arm can be deflected or pivoted relative to the base carrier via a pivot axis,
the base carrier can be arranged on a crawler of the sewer inspection and/or maintenance system, and
the base carrier
is movable or displaceable along a movement axis relative to the crawler, and/or
can be rotated about an axis of rotation relative to the crawler.

2. A sewer inspection and/or maintenance system comprising a crawler and a positioning system for positioning devices in a sewer, wherein
the positioning system has a lifting arm which is arranged on a base carrier,
the base carrier is arranged on the crawler,
the lifting arm can be deflected or pivoted relative to the base carrier via a pivot axis, and
the base carrier
is movable or displaceable along a movement axis relative to the crawler, and/or
can be rotated about an axis of rotation relative to the crawler.

3. The positioning system according to claim 1, wherein a receiving unit is arranged at the free end of the lifting arm for receiving, in particular detachably receiving, the device.

4. The positioning system according to claim 1, wherein the lifting arm has at least two lifting arm sections which are coupled to one another in an articulated manner, preferably via a swivel joint, and wherein the free end of one of the two lifting arm sections is arranged on the base carrier in a deflectable or pivotable manner.

5. The positioning system according to claim 1, wherein
the base carrier is assigned a first controllable actuating means which is adapted
to deflect or pivot the lifting arm relative to the base carrier via the pivot axis, and/or
to move or displace the base carrier
along the movement axis relative to the crawler, and/or
to rotate it about the axis of rotation relative to the crawler, and/or
one of the two lifting arm sections is assigned a second controllable actuating means which is adapted to move the one lifting arm section relative to the other lifting arm section.

6. The positioning system according to claim 5, wherein an absolute encoder is assigned to the first controllable actuating means and/or the second controllable actuating means.

7. The positioning system according to claim 3, wherein the receiving unit can be pivoted relative to the lifting arm over a predetermined angular range, preferably over an angular range of 180°, particularly preferably over an angular range of 270°.

8. The positioning system according to claim 3, wherein the receiving unit
is rotatably mounted at the free end of the lifting arm, and/or
is designed in two parts, wherein a first part of the receiving unit is rotatable relative to the second part of the receiving unit.

9. The positioning system according to claim 1, wherein a pressurized duct is formed in the lifting arm.

10. The positioning system according to claim 9, wherein the pressurized duct is designed as a continuous pressurized duct from one end to the other end of the lifting arm, which is coupled to the crawler on the crawler side.

11. A positioning system for sewer inspection and/or maintenance systems for positioning a device in a sewer, wherein the positioning system has a lifting arm, wherein the device can be arranged at a free end of the lifting arm, wherein, in order to stabilize the device,
the device can be arranged indirectly via a gimbal at the free end of the lifting arm, and/or
the positioning system is movable in such a way that the movements of the positioning system correspond to the function of a gimbal.

12. The sewer inspection and/or maintenance system according to claim 2, wherein a receiving unit is arranged at the free end of the lifting arm for receiving, in particular detachably receiving, the device.

13. The sewer inspection and/or maintenance system according to claim 2, wherein the lifting arm has at least two lifting arm sections which are coupled to one another in an articulated manner, preferably via a swivel joint, and wherein the free end of one of the two lifting arm sections is arranged on the base carrier in a deflectable or pivotable manner.

14. The sewer inspection and/or maintenance system according to claim 2, wherein
the base carrier is assigned a first controllable actuating means which is adapted
to deflect or pivot the lifting arm relative to the base carrier via the pivot axis, and/or
to move or displace the base carrier
along the movement axis relative to the crawler, and/or
to rotate it about the axis of rotation relative to the crawler,
and/or
one of the two lifting arm sections is assigned a second controllable actuating means which is adapted to move the one lifting arm section relative to the other lifting arm section.

15. The sewer inspection and/or maintenance system according to claim 2, wherein a pressurized duct is formed in the lifting arm.
